(19) United States
(12) Patent Application Publication
(10) Pub. No.: US 2004/0010696 A1
(43) Pub. Date: Jan. 15, 2004

(54) Methods and systems for establishing trust of identity

(76) Inventors: Greg Cannon, Boynton Beach, FL (US); Walter Guy Scott, North Palm Beach, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/284,439

(22) Filed: Oct. 31, 2002

Related U.S. Application Data
(60) Provisional application No. 60/330,794, filed on Oct. 31, 2001.

(51) Int. Cl. H04L 9/00

(52) U.S. Cl. 713/186; 713/175

(57) ABSTRACT

The present invention relates to methods and systems for establishing trust in an identity of an individual in a transaction with a transacting entity. Trust is based on secure biometric data such as a captured print. In one environment, an individual uses an identification device at or near a terminal to carry out the transaction. For example, the identification device may be coupled to the terminal by a wireless or wired link. The terminal is coupled over a network to an identity service provider and/or the transacting entity.

### RELATED APPLICATIONS

This application claims priority under 35 U.S.C. § 119(e) to U.S. Provisional Application Ser. No. 60/330,794 (the '794 Prov. App.), filed Oct. 31, 2001, which is incorporated herein by reference in its entirety.

### FIELD OF THE INVENTION

The present invention relates generally to establishing a level of trust in an individual's identity prior to carrying out a transaction between an individual and a transacting entity.

### BACKGROUND OF THE INVENTION

Transactions are increasingly being carried out in variety of ways. Gone are the days when a buyer and seller had to meet face to face to conduct a transaction. Network communications and electronic terminals now allow individuals to carry out different types of transactions with remote transacting entities. Remote transacting entities increasingly rely on a level of trust in the identity of individuals prior to carrying out transactions with people. Different techniques have been used to establish the identity of the individual. These techniques have required a user to present a password, Personal Identification Number (PIN), and/or a signed credit/debit card to establish identity. Even transactions in person often require a level of trust in identity. Personal documentation, such as, a driver's license or passport, may need to be produced by an individual.

Many transactions are now vulnerable to fraud. Criminals or other unauthorized users can engage in unauthorized transactions by supplying stolen passwords, PINs, or credit cards. Also, valid transactions may not occur as they the requirements for establishing identity become too complicated. Individuals may forget or misplace PINs, passwords, or other required information.

Systems and methods are needed for establishing trust in an individual's identity which are secure and easy to use.

### BRIEF SUMMARY OF THE INVENTION

Embodiments of the present invention provide methods and systems for establishing trust in an identity of an individual in a transaction with a transacting entity. Trust is based on secure biometric data such as a captured print. In one environment, an individual uses an identification device at or near a terminal to carry out the transaction. For example, the identification device may be coupled to the terminal by a wireless or wired link. The terminal may be coupled over a network to an identity service provider and/or the transacting entity. Thus, according to the methods and systems of the present invention, trust of an identity can be established securely, simply and cost-effectively. Remote transactions between an individual and a transacting entity can be carried out simply and easily in a manner well-suited for widespread consumer applications with a high degree of trust in the identity of the individual. In establishing such trust in an identity, the presence of authorized or valid system elements, namely, the identification device, the terminal, and/or the identity service provider, is also verified through the use of public/private keys, digital signatures and/or certificates.

In one embodiment, sample print data and reference print data are sent from the identification device to a terminal. An identity service provider is also used to carry out triple extraction and matching operations. A method for establishing trust in an identity of an individual in a transaction with a transacting entity includes: detecting a sample print of the individual at an identification device, generating a print document that includes identity data associated with the individual, a reference print associated with the individual, and the detected sample print, and sending the generated print document to a terminal. At the terminal, the method includes forwarding the print document to an identity service provider. The method further includes retrieving a database print associated with the individual from a database, extracting minutia data from the reference print, sample print, and database print, determining a score indicative of a match condition of the extracted minutia data, and determining whether to trust the identity of the individual based on the score. In this way, the transaction between the individual and the transacting entity can proceed when the identity of the individual is determined to be trusted.

According to one feature, the generating step includes attaching a first digital signature to the print document. The first digital signature includes at least identity data encrypted with an individual private key associated with the individual. In one example, the individual private key is assigned by a certificate authority. According to another feature, the method includes retrieving an individual public key associated with the individual private key from a database based on the identity data in the print document, decrypting the attached first digital signature with the retrieved individual public key, and verifying the decrypted first digital signature to confirm an individual with access to individual private key sent the print document. In this way, trust of the identity of the individual is not permitted when the verifying step does not confirm an individual with access to individual private key sent the print document.

According to another feature, the trust determining step includes generating a boolean trust value based on the score. The boolean trust value indicates whether the identity of the individual is trusted or not trusted. A transaction with the transacting entity is only allowed to proceed when the boolean trust value indicates the identity of the individual is trusted.

According to another feature, the method further includes creating an identity document and attaching a second digital signature to the identity document. The second digital signature is made up of an identity service provider identifier encrypted with an identity service provider individual private key associated with the identity service provider. The method can also include the steps of decrypting the attached second digital signature with a public key associated with the identity service provider private key and verifying the decrypted second digital signature to confirm an identity service provider with access to the identity service provider private key sent the identity document. In this way, trust of the identity of the individual is not permitted when the verifying step does not confirm an identity service provider with access to the identity service provider private key sent the identity document.

In another embodiment, a method further includes the steps of sending a certificate that includes an individual public key associated with the individual private key to the terminal, retrieving an individual public key associated with the individual private key from the certificate, decrypting the attached first digital signature with the retrieved individual public key, and verifying the decrypted first digital signature. The verifying step confirms whether an individual with access to individual private key sent the print document. In this way, trust of the identity of the individual is not permitted when the verifying step does not confirm an individual with access to individual private key sent the print document. By sending the public key in a certificate, a database at the identity service provider need not include public key information, thereby saving cost and work incurred by the identity service provider.

In another embodiment, sample print data and reference minutia data are sent from the identification device to a terminal. Since minutia data is typically much smaller than print image data, this reduces the bandwidth required in a link between the identification device and the terminal compared to sending two prints. An identity service provider is also used to carry out extraction and matching operations. Only captured sample print needs to be extracted; however, a triple match of minutia data can be carried out.

In another embodiment, extraction is carried out at the identification device. Sample and reference minutia data are sent from the identification device to a terminal. Since minutia data is typically much smaller than print image data, this reduces the bandwidth required in a link between the identification device and the terminal compared to sending one or two prints. An identity service provider is also used to carry out a triple matching operation.

In still another embodiment, extraction and matching is carried out at the identification device. An identity document is sent from the identification device to a terminal. No identity service provider is needed. In still other embodiments, extraction and/or matching are carried out at the terminal. No identity service provider is needed.

In other embodiments, systems for establishing trust in an identity of an individual in a transaction with a transacting entity are provided. In those embodiments, a system includes an identification device, a terminal and/or an identity service provider. The identification device generates a print document including sample data and reference data. The terminal is communicatively coupled to the identification device. The terminal can facilitate or enable the transaction when trust has been established based on the sample data and the reference data. In one embodiment, an identity service provider performs at least one of extracting and matching operations on the sample data and the reference data. The identification device can be, but is not limited to, a handheld, wireless or plug-in personal identification device.

Further embodiments, features, and advantages of the present invention as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5A illustrates a wireless transceiver biometric device according to an embodiment of the invention.

FIG. 5B illustrates example environments in which the wireless transceiver biometric device of FIG. 1 can be used to complete different types of transactions.

FIG. 6A is a diagram of embodiments for establishing trust of identity in transactions according to the invention.

FIG. 6B is a diagram of an identification device, terminal, and an identity service provider according to according to embodiments of the present invention.

FIGS. 7 to 13 are diagrams that illustrate embodiments for establishing trust of identity in transactions according to the invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

The present invention provides methods and systems for establishing trust in an identity of an individual in a transaction with a transacting entity. The present invention can be used with many different types of remote transactions or transacting entities. Examples include, but are not limited to, transactions to purchase, rent, lease or license products or services or exchange data with transacting entities, such as, companies, governments, hospitals, universities, merchants, vendors, non-profit organization, education institutions, or other types of entities.

The present invention relates generally to an identification device and applications thereof. In one preferred embodiment, the present invention relates to an identification device with an inexpensive piezoelectric sensor element for obtaining biometric data or information, such as for a print, and using the obtained information to recognize and/or verify the identify of an individual. Any other known types of print sensor (such as a capacitive sensor, etc.) can be used. Print can be any type of print including, but not limited to, a print of all or part of one or more fingers, palms, toes, foot, hand, etc. A print can also be a rolled print, a flat print, or a slap print. The term “print data” or “print information” refers to digital data representative of an image of a print (e.g., a bitmap or other type of file or data structure).

II. Wireless Transceiver Biometric Devices

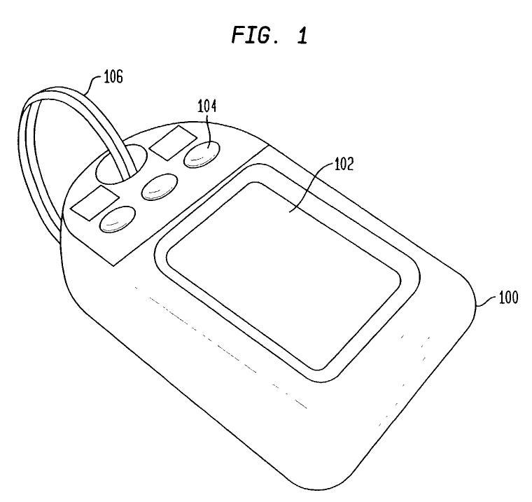

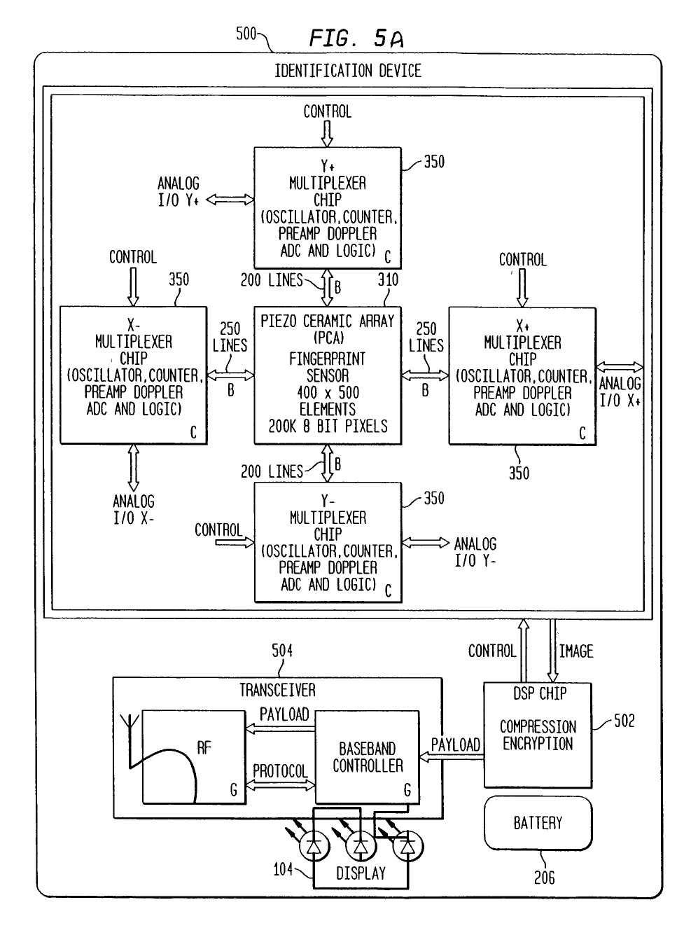

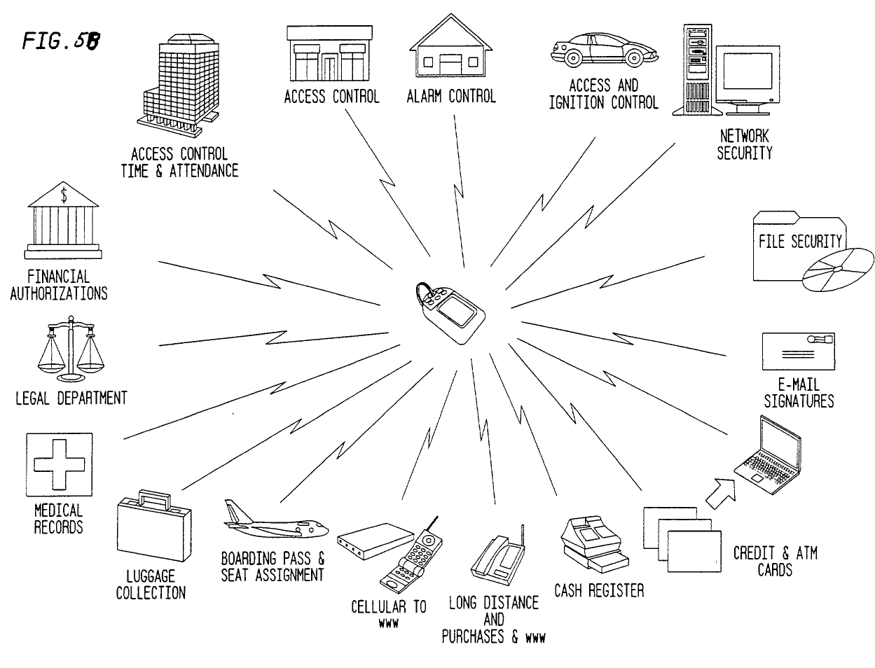

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

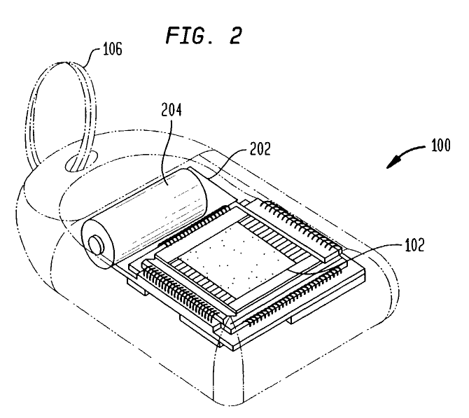

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below.

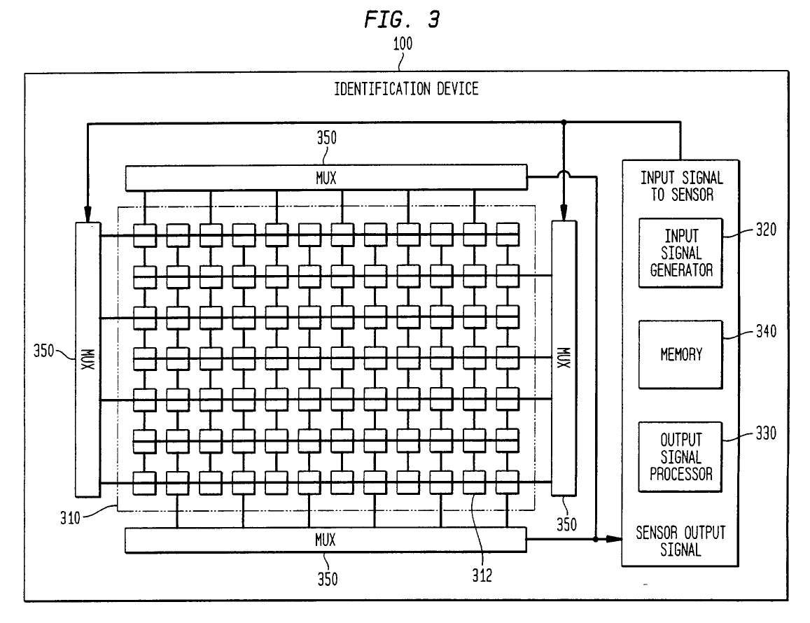

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the No. 60/330,794 Prov. App, which is incorporated by reference herein in its entirety.

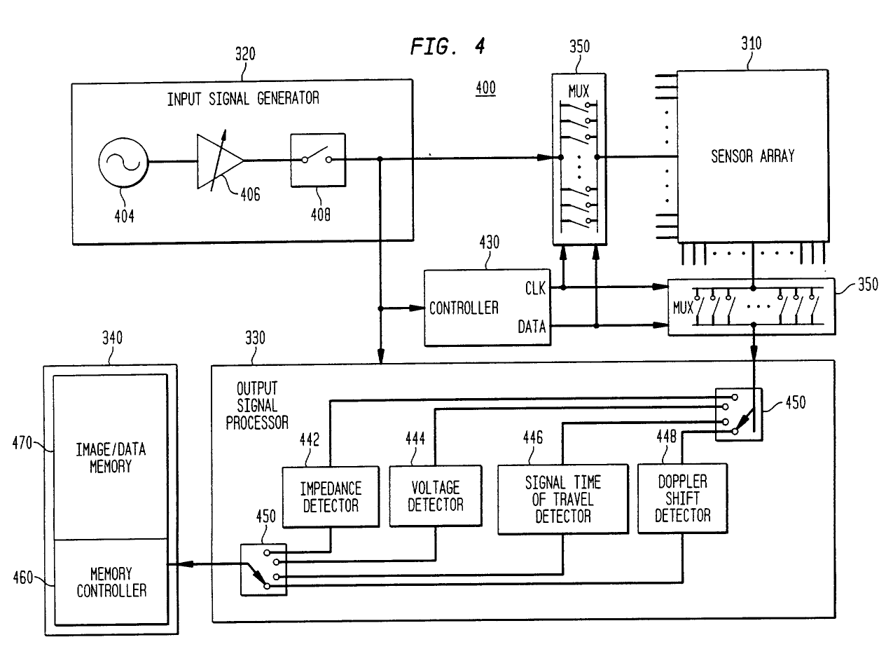

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. No. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5A illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used. As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11, and/or a wired or plug-in connection.

With continuing reference to FIG. 5A, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 5B illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

The wireless transceiver biometric devices described above may be used in a plethora of applications. The effective use of a biometric authentication-enabled device that incorporates the functionality of an identification device, such as the wireless transceiver biometric device described above, requires methods to configure the biometric authentication-enabled device. These methods must be cost efficient, and must not impair the integrity of the security inherent with the use of the unique characteristics associated with the biometric information being used.

IV. Establishing Trust of Identity in Transactions

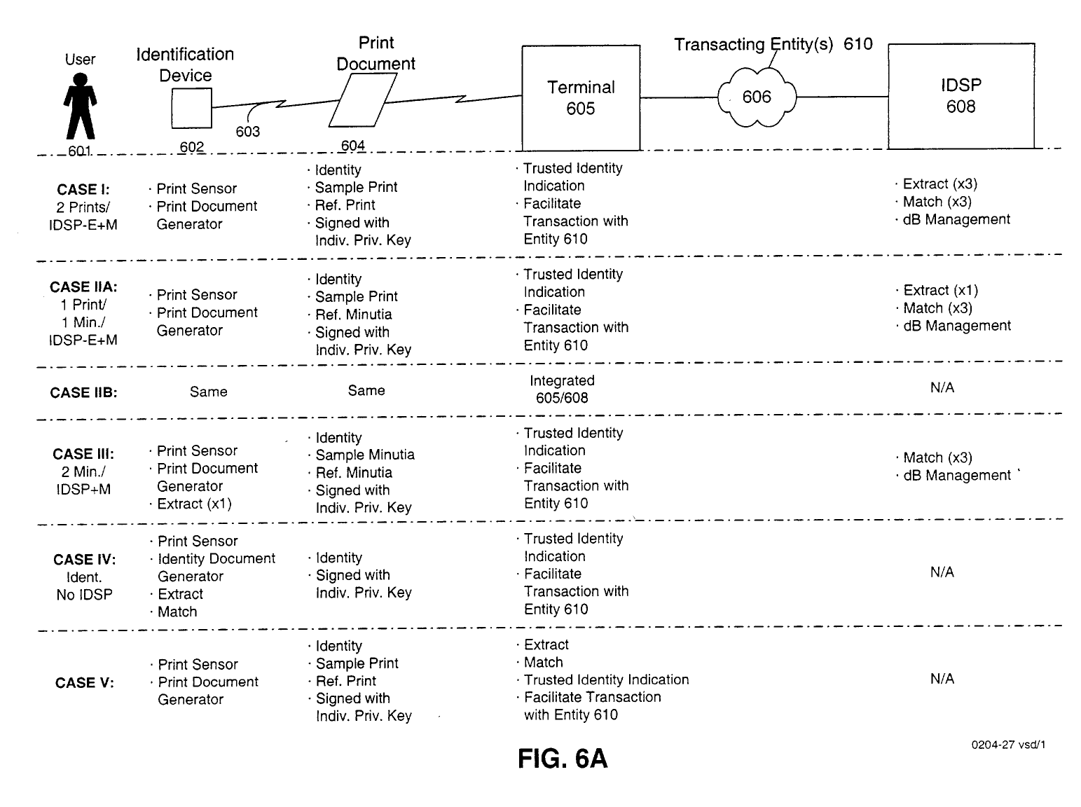

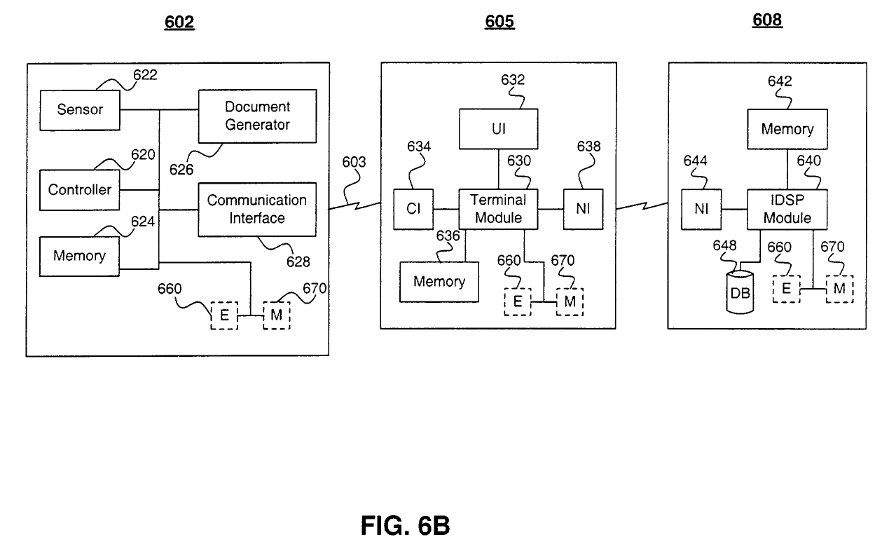

FIG. 6A is a diagram of embodiments for establishing trust of identity in transactions according to the present invention. User 601 wishes to perform a remote transaction with transacting entity 610. As shown in FIG. 6A, an identification device 602, terminal 605 and/or identification service provider (IDSP) 608 are provided to establish trust in the identity of user 601. Individual 601 uses identification device 602 at or near terminal 605. For example, identification device 602 can communicate with terminal 605 over the link 603. Link 603 can be any type of communication link including, but not limited to, a wireless link or a wired link through a plug-in module or other type of coupling. Terminal 605 communicates with transacting entity 610 over network 606. An IDSP 608 may also be coupled to terminal 605 over network 606. Network 606 can be any type of network or combination of networks such as, but not limited to, the Internet, a local area network, a piconet or other type of network.

FIG. 6B is a diagram of an identification device 602, terminal 605, and identity service provider 608 according to embodiments of the present invention. Identification device 602 includes controller 620, sensor 622, memory 624, document generator 626, and communication interface 628. Controller 620 controls and manages the operation of identification device 602. Sensor 622 captures an image of a print placed on identification device 602 by individual 601. In one preferred example, sensor 602 is a piezoceramic sensor as described above. The present invention for establishing trust is not so limited, and other types of print sensors can be used including, but not limited to, ultrasound sensors, piezoelectric thin film sensors, capacitive sensors, and optical sensors. Memory 624 can be any type of memory. Memory 624, among other things, stores data such as sample print data, reference print data, identity data, individual private key, sample minutia data, and/or reference minutia data. Different combinations of all or part of this data may be stored depending upon a particular application of the present invention. Other examples of different types of data stored at identification device 602 are described below with respect to FIGS. 6A and 7-13. Identification device 602 can also include all or part of the components described above with respect to devices 100, 400, and 500. In one example, not intended to limited to the invention, identification device 602 can be a handheld, wireless print detection device such as described above with respect to devices 100, 400, and 500.

Document generator 626 generates a print document or an identity document. The content of a print document or an identity document can vary and depends upon the particular application of the present invention. Examples of different documents are described below with respect to FIGS. 6A and 7-13.

Communication interface (CI) 628 can be any type of communications interface for communicating with terminal 605 over link 603.

Terminal 605 includes terminal module 630, user-interface (UI) 632, communication interface (CI) 634, memory 636, and network interface (NI) 638. Terminal module 630 controls and manages operation of terminal 605. The operation of terminal 605 and terminal module 630 in embodiments of the present invention is described further with respect to FIG. 6A and process flow diagrams 7-13. User-interface (UI) 632 provides an interface (e.g., keyboard, touch screen, display, mouse, etc.) between user 601 and terminal 605. Communication interface (CI) 634 can be any type of communications interface for communicating with identification device 602 over link 603. In one feature, CI 628 and CI 634 support secure communication over link 603 such as, Secure Socket Layer (SSL) or other type of secure communication. Memory 636 can be any type of memory. Network interface (NI) 638 can be any type of network interface that enables terminal 605 to communicate over a network.

Identity service provider (IDSP) 608 includes IDSP module 640, memory 642, network interface 644, and database 648. IDSP module 640 controls and manages operation of IDSP 608. The operation of IDSP 608 and IDSP 640 in embodiments of the present invention is described further with respect to FIG. 6A and process flow diagrams 7-13. Memory 642 can be any type of memory. Network interface (NI) 644 can be any type of network interface that enables IDSP 608 to communicate over a network. Database 648 can be any type of database.

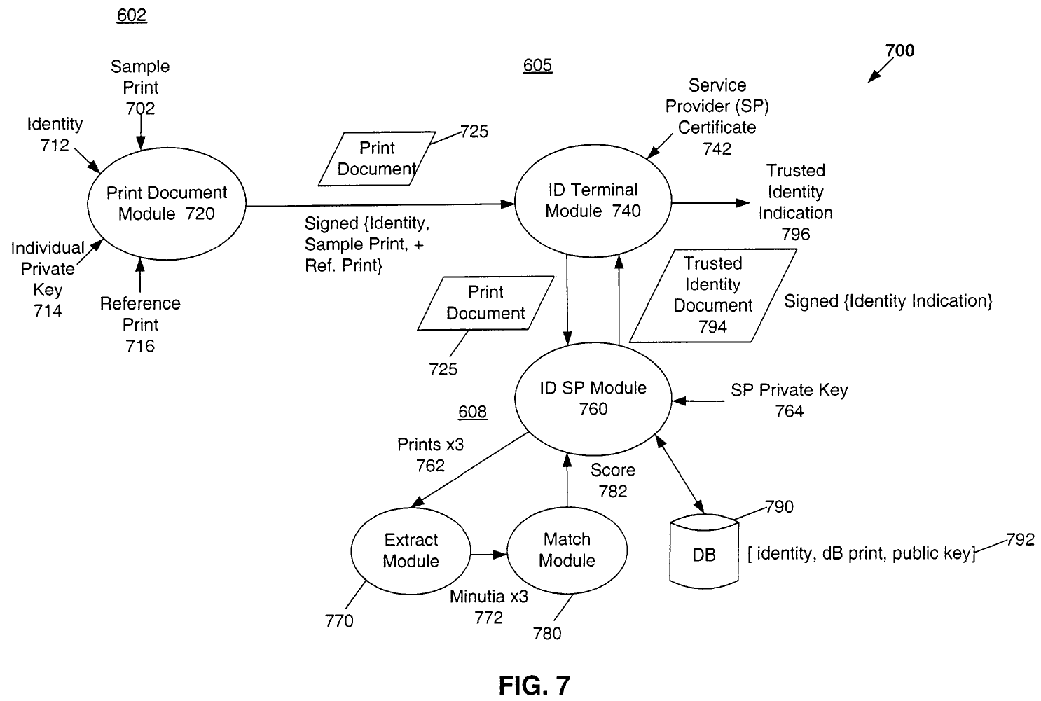

As shown in FIG. 6B, an extracting module (E) 660 can be provided in either the identification device 602, terminal 605, or IDSP 608. Any type of extracting algorithm for extracting minutia data from print data can be used as is well-known in fingerprint analysis. Similarly, a matching extracting module (M) 660 can be provided in either the identification device 602, terminal 605, or IDSP 608. Any type of matching algorithm for matching minutia data can be used as is well-known in fingerprint analysis. Both the extracting module 660 and the matching module 670 are shown with dashed lines to indicate their location can vary in different embodiments of the present invention as described further below with respect to FIG. 6 and process flow diagrams FIGS. 7-13.

The present invention provides different methods and systems for establishing trust in the identity of individual 601. First, an overview of different methods and systems will be described with respect to FIG. 6A in cases I through V. Each of the cases I through V will then be described in further detail with respect to FIGS. 7 to 13. For brevity and convenience, methods of the present invention are described with reference to identification device 602, terminal 605, or IDSP 608; however, these methods are not intended to be necessarily limited to specific structure.

In case I, sample print data and reference print data are sent from identification device 602 over link 603 to terminal 605. Identification device 602 includes a print sensor and a print document generator. The print document generator generates print document 604. Print document 604 in case I includes identity data, sample print, and reference print data. The identity data is signed with an individual private key and attached to the print document 604. Terminal 605 forwards the print document 604 to IDSP 608. IDSP 608 verifies the signed print document, performs a triple extract operation, triple match operation, and manages a database. The triple extract operation is performed on sample print data and reference print data from the signed print document and database print data obtained from a database (not shown). IDSP 608 returns a boolean identity trust value to terminal 605. Terminal 605 provides a trusted identity identification based on the output of IDSP 608. Terminal 605 facilities or enables the transaction between user 601 and transacting entity 610 when trust has been established. Methods and systems for establishing trust according to case I are described in further detail below with respect to FIG. 7.

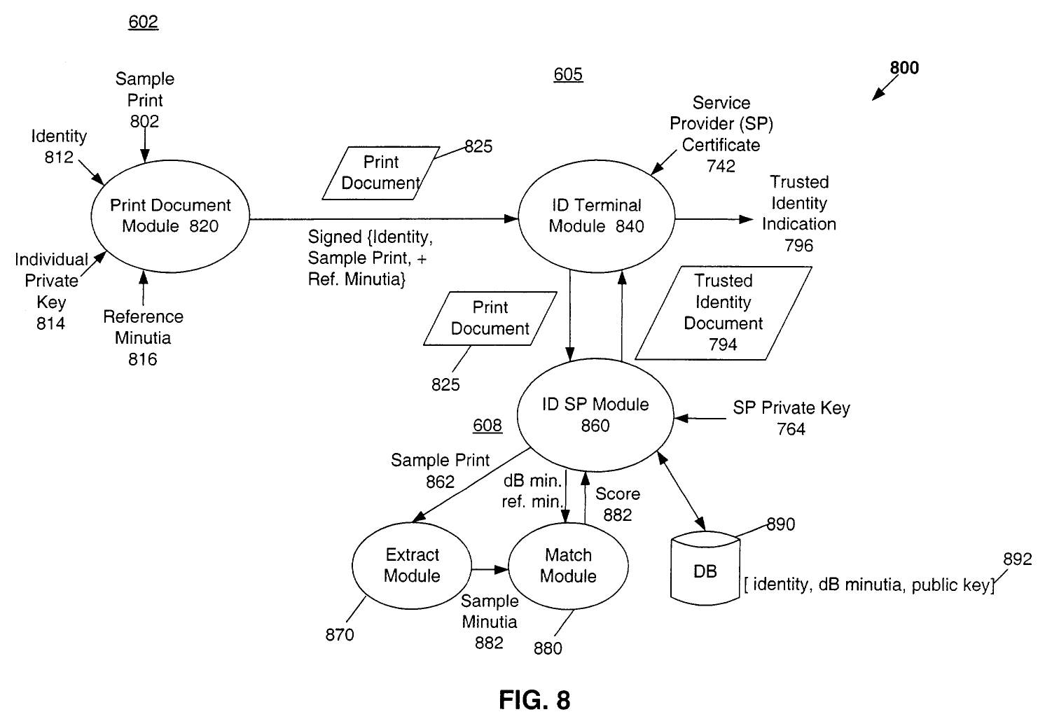

According to a further embodiment, as shown in FIG. 6, in case IIA a sample print data and reference minutia data are sent from identification device 602 to terminal 605. Identification device 602 includes a print sensor and print document generator. Print document generator generates print document 604. Print document 604 includes identity data, sample print data and reference minutia data. The identity data is signed with an individual private key and attached to print document 604. Terminal 605 forwards print document 604 to IDSP 608. IDSP 608 verifies the signed print document, performs a single extract operation on the sample print data, and performs a triple match operation on sample minutia, reference minutia and database minutia data. IDSP 608 also includes database management. As in case I, a boolean identity trust value indicative of whether trust is established for user 601's identity is then sent to terminal 605. Terminal 605 generates a trusted identity indication and facilitates the transaction between user 601 and transacting entity 610 when trust is established. Methods and systems according to embodiments of the present invention including case IIA are described in further detail below with respect to FIG. 8.

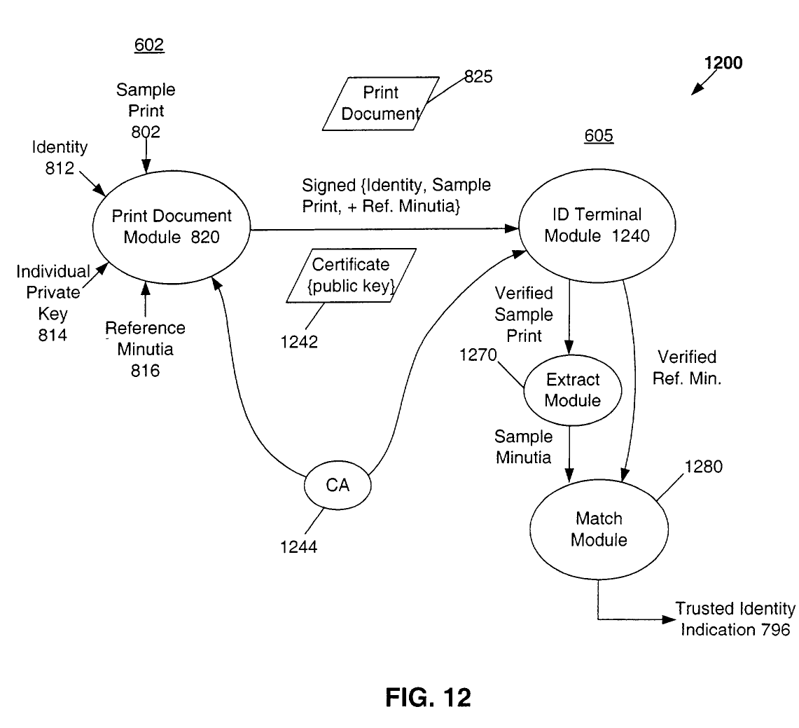

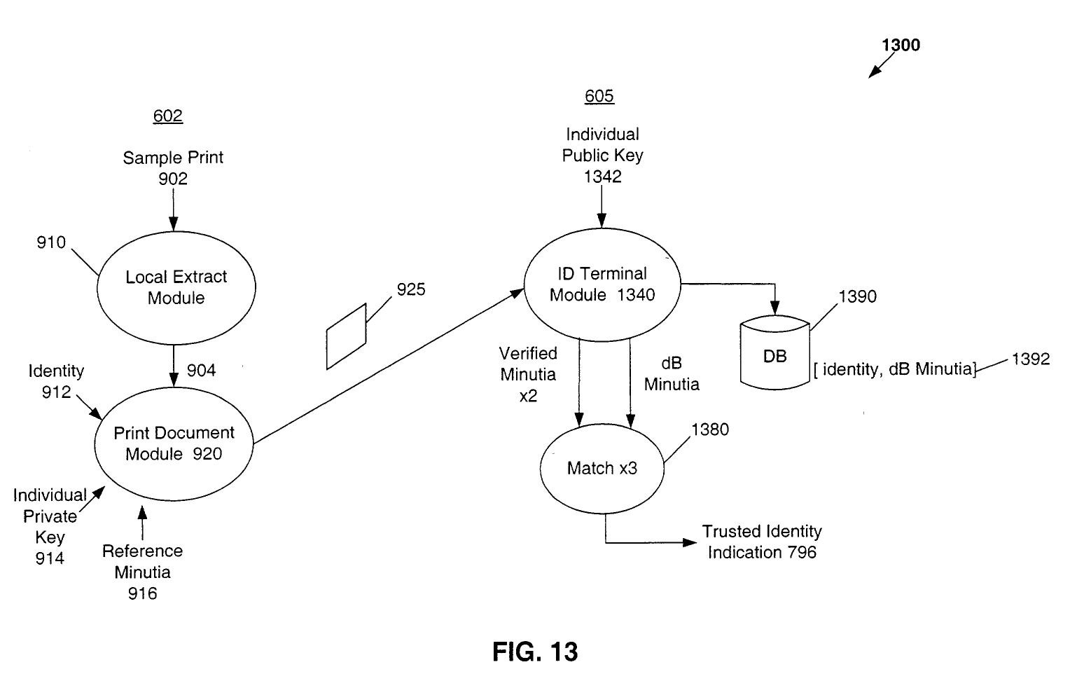

Case IIB is similar to case IIA except functionality of the identity service provider 608 is integrated into terminal 605. As a result, terminal 605 carries out extract and match operations. Terminal 605 further performs the steps of indicating a trusted identity and facilitating transaction between user 601 and entity 610. Example embodiments of a terminal 605 that integrates the functionality of IDSP 608 are described further below with respect to FIGS. 12 and 13.

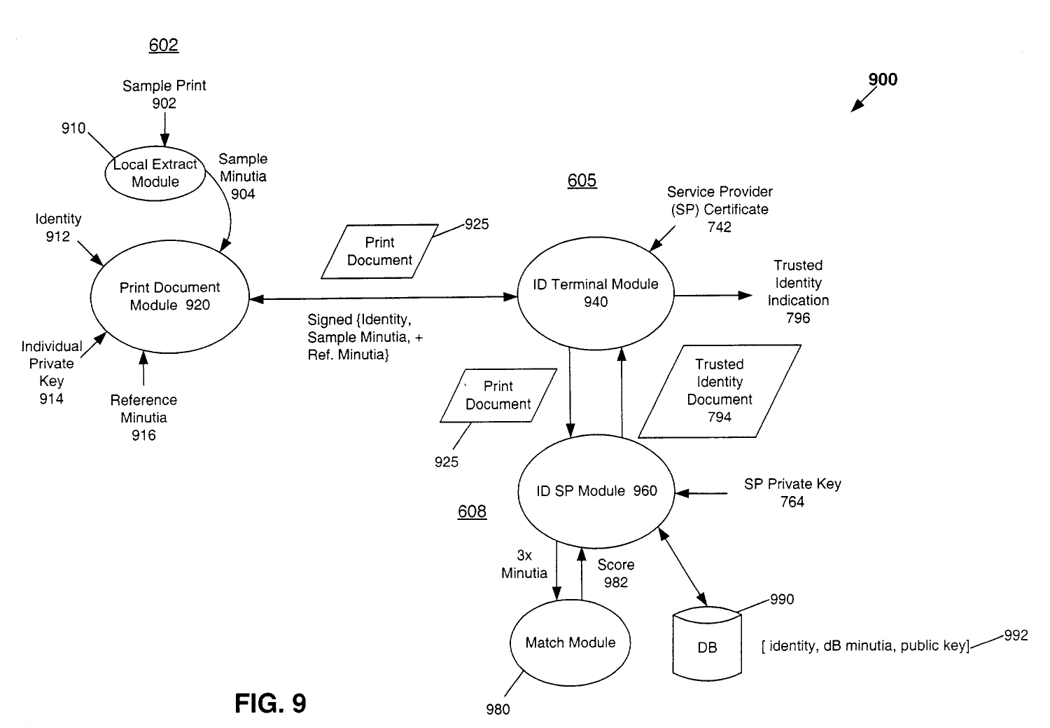

In case III, extraction is carried out in identification device 602. Identification device 602 includes a print sensor, a print document generator and a local extract module. The print document generator generates a print document 604 that includes identity data, sample minutia data, and reference minutia data. Print document 604 is signed with an individual private key. At least the identity data is attached as a digital signature encrypted by the individual private key. Terminal 605 forwards print document 604 to IDSP 608. IDSP 608 verifies the signed print document and performs a triple match and database management operations. The work of IDSP 608 is reduced since it does not perform extraction. IDSP 608 returns a boolean identity trust value to terminal 605. Terminal 605 then provides a trusted identity indication and facilities transaction between user 601 and entity 610. Aspects of case III will be described further with respect to FIG. 9. As described above with respect to case IIB, terminal 605 can also integrate the functionality of IDSP 608 in case III. An example of the operation of a terminal that integrates the triple matching and database management operations of IDSP 608 is described further below with respect to FIG. 13.

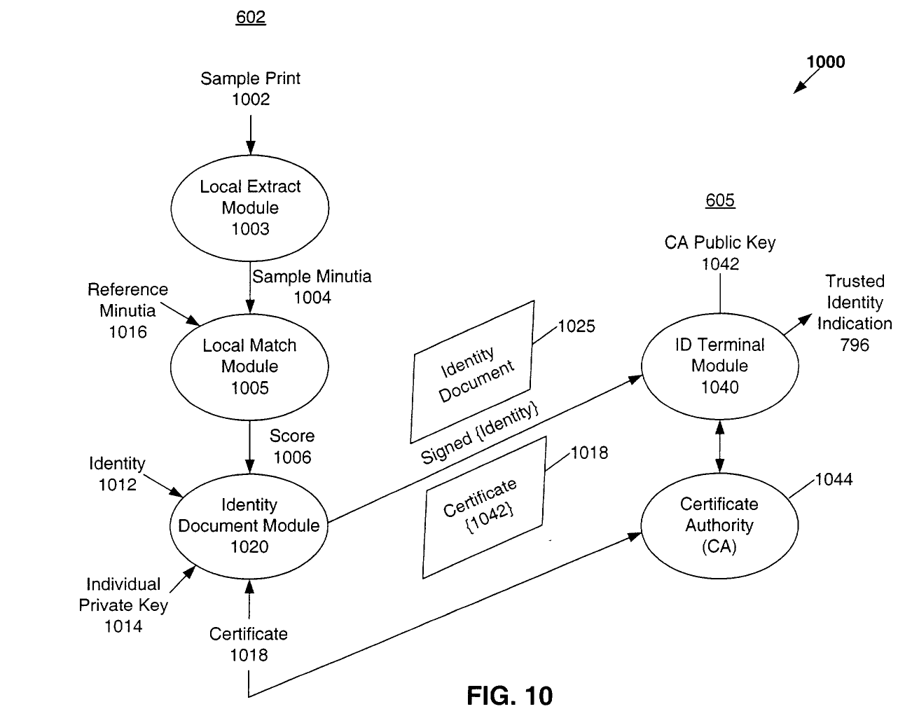

In case IV, identity service provider 608 is omitted. Identification device 602 includes a print sensor, identity document generator, and carries out extract and match operations. Identity document generator generates an identity document 604. This identity document 604 includes identity data. As with the print document, the identity document can be signed with an individual private key. For example, a digital signature can be attached to the document which is made up of identity data encrypted with the individual private key. Terminal 605 then receives the identity document and generates a trusted identity indication when the identity data indicates trust has been established. Terminal 605 then verifies the signed document and facilities the transaction between user 601 and entity 610. Embodiments of case IV are described further below with respect to FIG. 10.

In case V, identity service provider 608 is omitted. Extract and match operations are carried out at terminal 605. Identification device 602 includes a print sensor and print document generator. The print document generator generates print document 604 containing identity data, sample print data, and reference print data. As in the other cases, print document 604 can be signed with an individual private key. For example, a digital signature made up of identity data encrypted with an individual private key can be attached. Terminal 605 extracts sample minutia data and reference minutia data. Alternatively, print document 604 can contain identity data, sample print data, and reference minutia data. Terminal 605 then only needs to extract sample minutia data. Terminal 605 determines whether a match condition is met. Terminal 605 then generates a trusted identity indication when trust has been established and facilitates transaction between user 601 and entity 610. An embodiment of case V is described further below with respect to FIG. 12.

FIG. 7 shows a system 700 for establishing trust in an identity of an individual 601 in a transaction with transacting entity 610 according to an embodiment of the present invention. System 700 includes a print document module 720, identity (ID) terminal module 740, and identity service provider (IDSP) module 760. Print document module 720 is implemented as part of identification device 602. Print document module 720 can be implemented in software, firmware, and/or hardware.

Print document module 720 receives a detected sample print 702. For example, sample print 702 can be detected when an individual 601 places a object having a print such as their finger on a sensor element. Print document module 720 generates print document 725. Print document 725 includes identity data 712, sample print 702, and reference print 716. Identity data 712 can be any type of data associated with individual 601 including but not limited to name, email address, password/user name, social security number or any other identifying information. Individual private key 714 is a private key associated with the individual. In one preferred embodiment, individual private key 714 is assigned by certificate authority and stored in identification device 602. Reference print 716 is data representative of a print image of the individual 601. In one example, reference print 716 is a high-quality bit map image of a print of user 601. Identity 712, individual private key 714, and reference print 716 are preferably stored in identification device 602 prior to a current use of the device 602 by user 601.

According to a further feature, print document 725 is signed. In one example, a first digital signature is attached to print document 725. The first digital signature is made up of at least the identity data 712 encrypted with individual private key 714. The signed print document 725 is then sent to ID terminal module 740 in terminal 605.

ID terminal module 740 forwards print document 725 to IDSP module 760. IDSP module 760 reads identity 712 and performs a lookup in database (dB) 790. In particular, the identity data 712 is used to look up a record 792. Record 792 includes a database print and an individual public key associated with the individual associated with identity 712. IDSP module 760 then retrieves the associated individual public key from record 792 and decrypts the first digital signature. The decrypted first digital signature is verified to confirm that an individual with access to individual private key 714 sent print document 725. In this way, trust of the identity of the individual is not permitted when a print document 725 is sent by someone without access to a proper individual private key.

Once the first digital signature is verified, a set of three prints 762 are forwarded to extract module 770. The set of prints 762 include sample print 702 and reference print 716 obtained from print document 725 and the database print retrieved from record 792. Extract module 770 performs an extract operation on each of the prints. Any conventional extract operation may be used as is well known in fingerprint analysis to obtain minutia data. Extract module 770 outputs a set of three minutia data 772 to match module 780. The set of minutia data 772 represent minutia data corresponding to each of the sample print 702, reference print 716, and database print extracted at extract module 770. Match module 780 then analyzes each of the three sets of the minutia to perform a triple match comparison. Any conventional match algorithm or technique can be used to perform the triple match. Match modules 780 then determines a score 782 indicative of a match condition of the extracted minutia data. For example, the score can indicated whether a match was found or whether a match was not found. Alternatively, the score can indicate the number of matching minutia detail points or similarities that were found or any other type of score reporting. Match module 780 then sends score 782 to IDSP module 760. In one example, IDSP module 760 then determines whether to trust the identity of the individual based on the score 782 received from match module 780. If a score indicative of a high degree of matching minutia is received then IDSP module 760 sets a boolean trust value to indicate a trusted identity condition. If score 782 is representative of a poor or no match condition then IDSP module 760 sets a boolean trust value to indicate a no trust condition.

In one embodiment, IDSP module 760 sends a trusted identity document 794 to ID terminal module 740. Trusted ID document 794 includes the boolean trust value. This boolean trust value is also referred to as an identity indication. In one example, a second digital signature is attached to trusted identity document 794. The second digital signature is made up of an identity service provider identifier encrypted with an identity service provider (SP) private key 764. SP private key 764 is associated with the particular identity service provider that is hosting IDSP module 760.

Upon receipt of the trusted identity document 794, ID terminal module 740 decrypts the attached second digital signature with a public key associated with the SP private key 764. In one embodiment, ID terminal module 740 is previously provided with public keys corresponding to service provider private keys. In another embodiment, IDSP module 760 may request a certificate and then provide a service provider certificate 742 to ID terminal module 740. In one example, SP certificate 742 is generated by a certificate authority (CA). SP certificate 742 includes the public key associated with SP private key 764. The decrypted second digital signature is then verified to confirm that the identity service provider with access to SP private key 764 sent the identity document 794. In this way, trust of the identity of the individual is not permitted when an identity service provider with access to an identity service provider private key is confirmed as being the actual sender of the identity document.

ID terminal module 740 then outputs trusted identity indication 796. Trusted identity indication 796 indicates whether the identity of individual 601 is trusted or whether the identity is not trusted. For example, trusted identity indication 796 can be a visual or audio indication at terminal 605 such as a light or beep. Trusted identity indication 796 can also be a register, flag or semaphore set internally to indicate whether an identity is trusted. Other indications are possible. When the identity is trusted then ID terminal module 740 proceeds to facilitate or initiate a transaction between the trusted user 601 and transacting entity 610.

FIG. 8 shows a system 800 for establishing trust in an identity of an individual 601 in a transaction with a transacting entity 610 according to a further embodiment of the present invention. System 800 includes print document module 820, ID terminal module 840, and IDSP module 860. In one embodiment, print document module 820 is provided in identification device 602. ID terminal module 840 is provided at terminal 605. IDSP module 860 is provided at IDSP 608.

Print document module 820 receives sample print 802. Sample print 802 for example can be detected (also referred to as captured) at identification device 602. Similar to print document module 720, print document 820 generates a print document 825. Print document 825 includes identity data 812, reference minutia data 816, and sample print 802. Sample print 802 can be any type of digital data representative of an image of a print of individual 601. Identity 812 is any type of data associated with the individual. Reference minutia 816 is reference minutia data associated with individual 601. In one example, identity data 812, individual private key 814, and reference minutia data 816 are stored in identification device 602 prior to use of device 602 by user 601. In one implementation, individual private key 814 is issued by a certificate authority.

Print document 825 includes identity data 812, reference minutia 816, and sample print 802. According to one feature of the present invention, a first digital signature can be attached to print document 825. The first digital signature is made up of identity data 812 encrypted with individual private key 814. Signed print document 825 is then sent to ID terminal module 840. ID terminal module 840 forwards print document 825 to IDSP module 860.

IDSP module 860 verifies the signed document 825 using a public key from database 890, as described above with respect to IDSP module 760. Once the signature of the signed document 825 is verified, IDSP module 860 then sends sample print 862 to extract module 870. Extract module 870 extracts sample minutia data 882 from sample print 862. Sample minutia data 882 is forwarded to match module 880. IDSP module 860 also forwards reference minutia 816 obtained from print document 825 and database minutia obtained from a look up of record 892 to match module 880. Match module 880 then generates a score 882. IDSP module 860 then generates a trusted identity document 794 signed with SP private key 764, as described above with respect to FIG. 7. ID terminal module 840 verifies document 794, outputs a trusted identity indication 796, and facilitates a transaction with entity 610 when trust is present as described above with respect to FIG. 7.

FIG. 9 is a diagram of a system 900 for establishing trust in an identity of an individual 601 in a transaction with transacting entity 610 according to a further embodiment of the present invention. System 900 includes print document module 920, ID terminal module 940, and IDSP module 960. A local extract module 910 is provided along with print document module 920 in an identification device 602. Local extract module 910 extracts sample minutia 904 from sample print 902. Print document 920 then generates print document 925. Print document 925 includes identity data 912, sample minutia 904, and reference minutia 916. According to a further feature, print document 925 is signed with a first digital signature. In one example, the first digital signature is attached to print document 925 and is made up of identity data 912 encrypted with individual private key 914.

ID terminal module 940 forwards print document 925 to IDSP module 960. IDSP module 960 then performs a lookup in database 990 to find record 992 associated with identity 912. IDSP module 760 retrieves public key from record 992 and uses the public key to decrypt the attached first digital signature. IDSP module 960 then verifies the decrypted first digital signature to confirm an individual with access to individual private key 914 sent print document 925.

When the first digital signature has been verified, IDSP module 960 forwards a set of minutia data consisting of reference minutia 916, sample minutia 904, and the retrieved database minutia to match module 980. Match module 980 then generates a score 982. Based on score 982, IDSP module 960 then generates a trusted identity document 794 signed with SP private key 764, as described above with respect to FIG. 7. ID terminal module 940 verifies document 794, outputs a trusted identity indication 796, and facilitates a transaction with entity 610 when trust is present, as described above with respect to FIG. 7.

FIG. 10 shows a system 1000 for establishing trust according to a further embodiment of the present invention. In this embodiment, system 1000 includes local extraction module 1003, local match module 1005, identity document module 1020, and ID terminal module 1040. In this embodiment, an IDSP module as described with respect to previous FIGS. 7 to 9 is not needed. Local extract module 1003, local match module 1005, and identity document module 1020 are each provided in identification device 602. Local extraction module 1003 extracts minutia from sample print 1002. Sample minutia data 1004 is then output to local match module 1005. Local match module 1005 determines a score 1006 based on a comparison of sample minutia 1004 with reference minutia 1016. Local extract module 1003 can be any type of conventional extract module as is well known in fingerprint technology. Local match module 1005 can use any conventional matching algorithm or technique as is well known in fingerprint analysis. Identity document module 1020 then generates identity document 1025 based on score 1006.

Identity document 1025 includes a boolean identity trust value representative of whether identity has been established as being trusted or whether the identity has not been established as trustworthy. In one example, the boolean identity trust value is set based on score 1006 similar to the boolean trust value determined as described with respect to FIG. 7. According to one example, the identity document 1025 is a signed identity document. For example, a first digital signature is attached. The first digital signature can be made up of identity data 1012 encrypted with individual private key 1014.

ID terminal module 1040 receives signed identity document 1025. Identity document module 1020 also requests a certificate be issued by certificate authority 1044. Certificate authority (CA) sends certificate 1018 to identity document module 1020. This certificate is generated by CA 1044 and includes a individual public key 1042 associated with an individual private key 1014. Certificate 1018 including public key 1042 is then sent to ID terminal module 1040. ID terminal module 1040 extracts individual public key 1042 from certificate 1018. ID terminal module 1040 then uses public key 1042 to verify the first digital signature. In particular, ID terminal module 1040 decrypts the first digital signature with public key 1042 and verifies that the decrypted first digital signature was generated by an individual with access to individual private key 1014. In this way, ID terminal module 1040 confirms an individual with access to individual private key 1014 actually sent the signed identity document 1025. Certificate authority 1044 can be any type of conventional certificate authority.

ID terminal module 1040 issues a trusted identity indication 796. ID terminal module 1040 can then facilitate or initiate the transaction between individual 601 and transacting entity 610 when trust has been established.

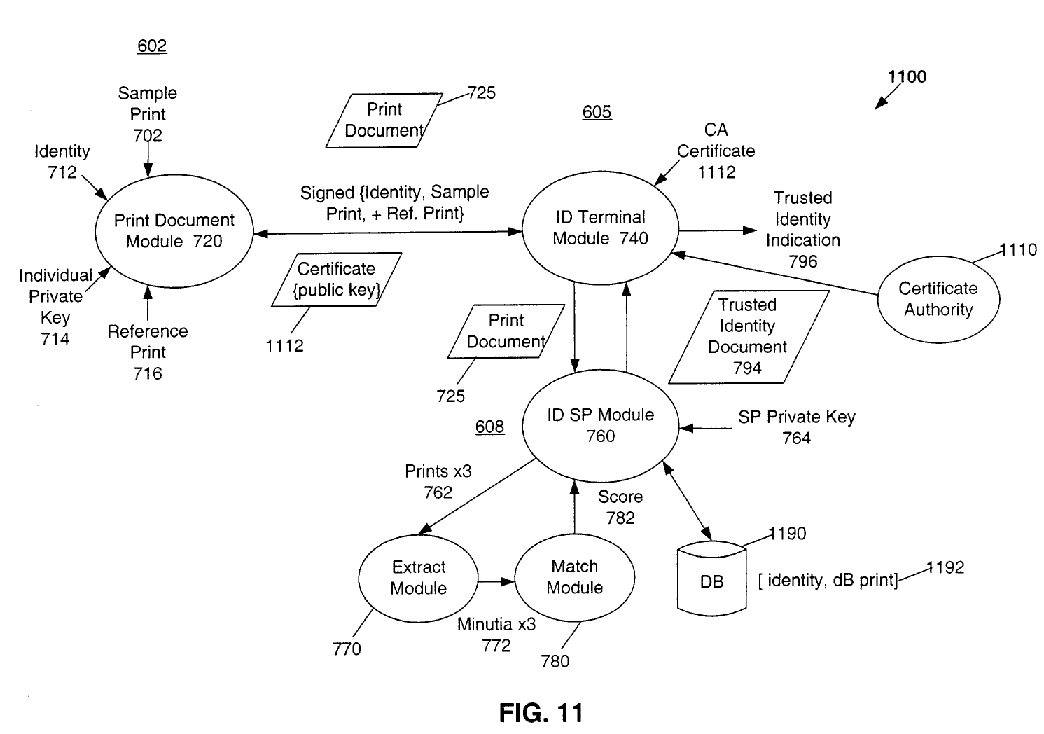

FIG. 11 is a diagram of a system 1100 for establishing trust and the identity of an individual according to a further embodiment of the present invention. Elements of system 1100 are similar to those of system 700 described above with respect to FIG. 7, except that certificates are used to obtain individual public key information rather than storing individual public key information in a database at IDSP module 760. For example, as shown in FIG. 11, print document module 720 requests a certificate 1112 be issued by a certificate authority 1110. Print document module 720 then sends the issued certificate 1112, which includes an individual public key, to ID terminal module 740.

ID terminal module 740 then obtains individual public key from certificate 1112. ID terminal module 740 can then use the individual public key to verify that the signed print document 725 was sent by an individual with access to individual private key 714. In other words, ID terminal module 740 can verify that print document 725 was properly signed. IDSP module 760 then need not obtain a individual public key from database 1190. This simplifies the work of IDSP module 760. Database 1190 is also simpler as records 1192 need only include identity information and database print information associated with each individual.

FIG. 12 is a diagram of a system 1200 for establishing trust in the identity of the individual 601 according to a further embodiment of the present invention. In system 1200, an identity service provider module is no longer needed as a separate entity, rather functionality of the identity service provider module has been integrated with functionality of the ID terminal module 1240 at terminal 605. System 1200 includes a print document module 820, ID terminal module 1240, extract module 1270, and match module 1280. Print document module 820 is provided at identification device 602. ID terminal module 1240, extract module 1270 and match module 1280 are provided at terminal 605. IDSP 608 is not needed.

As described previously with respect to FIG. 8, print document module 820 generates a signed print document 825 and sends signed print document 825 to ID terminal module 1240. ID terminal module 1240 then verifies the first digital signature of signed print document 825 using a public key obtained from certificate 1242. Certificate 1242 can be generated by certificate authority 1244 as is well known. In particular, print document module 820 can request a certificate 1242 using its individual private key 814 from CA 1244. CA 1244 will then issue a certificate 1242 that includes the associated individual public key within the certificate.

When the first digital signature is verified, ID terminal module 1240 proceeds to send a sample print 802 from the verified print document 825 to extract module 1270. Extract module 1270 extracts sample minutia data and forwards the sample minutia data to match module 1280. ID terminal module 1240 also forwards reference minutia 816 from the verified signed print document 825 to match module 1280. Match module 1280 generates a trusted identity indication 796 based on the determined matched condition between sample minutia and reference minutia 816. ID terminal module 1240 can facilitate or initiate transaction between individual 601 and transacting entity 610 when trust has been established.

FIG. 13 is a diagram of a system 1300 for establishing trust according to a further embodiment of the present invention. System 1300 includes local extract module 910, print document module 920, ID terminal module 1340, match module 1380, and database 1390. Local extract module 910 and print document module 920 are provided at identification device 602. ID terminal module 1340, match module 1380 and database 1390 are provided at terminal 605. IDSP 608 is omitted. System 1300 is similar to system 900 described above except that functionality is integrated at terminal 605. In particular, ID terminal module 1340 received signed print document 925. ID terminal module 1340 uses a public key obtained from a certificate to verify a signature attached to signed print document 925. When the signature is verified, sample minutia 904 and reference minutia 916 from document 925 are forwarded to match module 1380. Similarly, ID terminal module 1340 can use identity data in document 925 to perform a look up in database 1390 to obtain record 1392. Database minutia data is then retrieved from record 1392 and forwarded to match module 1380. Match module 1380 then outputs a trusted identity indication 796 based upon the match condition determined by match module 1380. ID terminal 1340 can then facilitate or initiate a transaction between individual 601 and transacting entity 610 when trust has been established.

In many of the above examples, a boolean identity trust value was included in trusted identity document 794. In alternative embodiments, a score (e.g., 782, 882, 982) is contained in document 794 or 1025. A boolean identity trust value is then determined based on the score at terminal 605 prior to generating a trusted identity indication 796, 1046.

### V. CONCLUSION

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method for establishing trust in an identity of an individual in a transaction with a transacting entity, comprising:
detecting a sample print of the individual at an identification device;
generating a print document that includes: identity data associated with the individual, a reference print associated with the individual, and the detected sample print;
sending the generated print document to a terminal;
forwarding the print document to an identity service provider;
retrieving a database print associated with the individual from a database;
extracting minutia data from the reference print, sample print, and database print;
determining a score indicative of a match condition of the extracted minutia data; and
determining whether to trust the identity of the individual based on the score, whereby, the transaction between the individual and the transacting entity can proceed when the identity of the individual is trusted.

2. The method of claim 1, wherein said generating step includes attaching a first digital signature to the print document, wherein the first digital signature comprising at least the identity data encrypted with an individual private key associated with the individual.

3. The method of claim 2, wherein the individual private key is assigned by a certificate authority.

4. The method of claim 2, further comprising:
retrieving an individual public key associated with the individual private key from the database based on the identity data in the forwarded print document;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

5. The method of claim 1, wherein said trust determining step comprises generating a boolean trust value based on the score indicating whether the identity of the individual is trusted or not trusted.

6. The method of claim 5, further comprising:
creating an identity document;
attaching a second digital signature to the identity document, wherein the second digital signature comprises an identity service provider identifier encrypted with an identity service provider individual private key associated with the identity service provider;
decrypting the attached second digital signature with a public key associated with the identity service provider private key; and
verifying the decrypted second digital signature to confirm an identity service provider with access to the identity service provider private key sent the identity document; whereby, trust of the identity of the individual is not permitted when said verifying step does not confirm an identity service provider with access to the identity service provider private key sent the identity document.

7. The method of claim 6, further comprising:
obtaining the public key associated with the identity service provider private key from a certificate.

8. The method of claim 5, further comprising enabling the transaction with the transacting entity to proceed when the boolean trust value indicates the identity of the individual is trusted.

9. The method of claim 2, further comprising:
sending a certificate that includes an individual public key associated with the individual private key to the terminal;
retrieving an individual public key associated with the individual private key from the certificate;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

10. The method of claim 9, wherein the certificate is generated by a certificate authority.

11. A method for establishing trust in an identity of an individual in a transaction with a transacting entity, comprising:
detecting a sample print of the individual at an identification device;
generating a print document that includes: identity data associated with the individual, reference minutia data associated with the individual, and the detected sample print;
sending the generated print document to a terminal;
forwarding the print document to an identity service provider;
retrieving database minutia data associated with the individual from a database;
extracting sample minutia data from the sample print;
determining a score indicative of a match condition of the extracted sample minutia data, the reference minutia data, and the database minutia data; and
determining whether to trust the identity of the individual based on the score, whereby, the transaction between the individual and the transacting entity can proceed when the identity of the individual is trusted.

12. The method of claim 11, wherein said generating step includes attaching a first digital signature to the print document, wherein the first digital signature comprising at least the identity data encrypted with an individual private key associated with the individual.

13. The method of claim 12, wherein the individual private key is assigned by a certificate authority.

14. The method of claim 12, further comprising:
retrieving an individual public key associated with the individual private key from the database based on the identity data in the forwarded print document;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

15. The method of claim 11, wherein said trust determining step comprises generating a boolean trust value based on the score indicating whether the identity of the individual is trusted or not trusted.

16. The method of claim 15, further comprising:
creating an identity document;
attaching a second digital signature to the identity document, wherein the second digital signature comprises the boolean trust value encrypted with an identity service provider individual private key associated with the identity service provider; and further comprising:
decrypting the attached second digital signature with a public key associated with the identity service provider private key; and
verifying the decrypted second digital signature to confirm an identity service provider with access to the identity service provider private key sent the identity document; whereby, trust of the identity of the individual is not permitted when said verifying step does not confirm an identity service provider with access to the identity service provider private key sent the identity document.

17. The method of claim 16, further comprising:
obtaining the public key associated with the identity service provider private key from a certificate.

18. The method of claim 15, further comprising enabling the transaction with the transacting entity to proceed when the boolean trust value indicates the identity of the individual is trusted.

19. A method for establishing trust in an identity of an individual in a transaction with a transacting entity, comprising:
detecting a sample print of the individual at an identification device;
extracting sample minutia data from the sample print at the identification device;
generating a print document that includes: identity data associated with the individual, reference minutia data associated with the individual, and the extracted sample minutia data;
sending the generated print document to a terminal;
forwarding the print document to an identity service provider;
retrieving a database print associated with the individual from a database;
determining a score indicative of a match condition of the extracted sample minutia data, the reference minutia data, and the database minutia data
determining whether to trust the identity of the individual based on the score, whereby, the transaction between the individual and the transacting entity can proceed when the identity of the individual is trusted.

20. The method of claim 19, wherein said generating step includes attaching a first digital signature to the print document, wherein the first digital signature comprising at least the identity data encrypted with an individual private key associated with the individual.

21. The method of claim 20, wherein the individual private key is assigned by a certificate authority.

22. The method of claim 20, further comprising:
retrieving an individual public key associated with the individual private key from the database based on the identity data in the forwarded print document;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

23. The method of claim 19, wherein said trust determining step comprises generating a boolean trust value based on the score indicating whether the identity of the individual is trusted or not trusted.

24. The method of claim 23, further comprising:
creating an identity document;
attaching a second digital signature to the identity document, wherein the second digital signature comprises an identity service provider identifier encrypted with an identity service provider individual private key associated with the identity service provider; and further comprising:
decrypting the attached second digital signature with a public key associated with the identity service provider private key; and
verifying the decrypted second digital signature to confirm an identity service provider with access to the identity service provider private key sent the identity document; whereby, trust of the identity of the individual is not permitted when said verifying step does not confirm an identity service provider with access to the identity service provider private key sent the identity document.

25. The method of claim 24, further comprising:
obtaining the public key associated with the identity service provider private key from a certificate.

26. The method of claim 23, further comprising enabling the transaction with the transacting entity to proceed when the boolean trust value indicates the identity of the individual is trusted.

27. A method for establishing trust in an identity of an individual in a transaction with a transacting entity, comprising:
detecting a sample print of the individual at an identification device;
extracting sample minutia data from the sample print at the identification device;
determining a score indicative of a match condition of the extracted sample minutia data and reference minutia data; and
determining whether to trust the identity of the individual based on the score, whereby, the transaction between the individual and the transacting entity can proceed when the identity of the individual is trusted.

28. The method of claim 27, further comprising:
generating an identity document at the identification device that includes a boolean trust value generated based on the score, the boolean trust value indicating whether the identity of the individual is trusted or not trusted; and
sending the generated identity document to a terminal.

29. The method of claim 28, wherein said generating step includes attaching a digital signature to the identity document, wherein the digital signature comprising at least the identity data encrypted with an individual private key associated with the individual; and further comprising:
sending a certificate that includes an individual public key associated with the individual private key to the terminal; and
decrypting the attached digital signature with the public key sent in the certificate; and
verifying the decrypted digital signature to confirm an individual with access to the individual private key sent the identity document; whereby, trust of the identity of the individual is not permitted when said verifying step does not confirm an individual with access to the individual private key sent the identity document.

30. The method of claim 29, wherein the certificate is generated by a certificate authority.

31. A method for establishing trust in an identity of an individual in a transaction with a transacting entity, comprising:
detecting a sample print of the individual at an identification device;
generating a print document that includes: identity data associated with the individual, reference minutia data associated with the individual, and the detected sample print;
sending the generated print document to a terminal;
extracting sample minutia data from the sample print;
determining a score indicative of a match condition of the extracted sample minutia data and the reference minutia data; and
determining whether to trust the identity of the individual based on the score, whereby, the transaction between the individual and the transacting entity can proceed when the identity of the individual is trusted.

32. The method of claim 31, wherein said generating step includes attaching a digital signature to the print document, wherein the first digital signature comprising at least the identity data encrypted with an individual private key associated with the individual, and
further comprising:
sending a certificate that includes an individual public key associated with the individual private key to the terminal;
retrieving an individual public key associated with the individual private key from the certificate;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

33. The method of claim 32, wherein the certificate is generated by a certificate authority.

34. The method of claim 31, wherein said trust determining step comprises generating a boolean trust value based on the score indicating whether the identity of the individual is trusted or not trusted.

35. A method for establishing trust in an identity of an individual in a transaction with a transacting entity, comprising:
detecting a sample print of the individual at an identification device;
extracting sample minutia data from the sample print;
generating a print document that includes: identity data associated with the individual, reference minutia data associated with the individual, and the extracted sample minutia data;
sending the generated print document to a terminal;
determining a score indicative of a match condition of the extracted sample minutia data, the reference minutia data, and database minutia data; and
determining whether to trust the identity of the individual based on the score, whereby, the transaction between the individual and the transacting entity can proceed when the identity of the individual is trusted.

36. The method of claim 35, wherein said generating step includes attaching a digital signature to the print document, wherein the first digital signature comprising at least the identity data encrypted with an individual private key associated with the individual, and
further comprising:
sending a certificate that includes an individual public key associated with the individual private key to the terminal;
retrieving an individual public key associated with the individual private key from the certificate;
decrypting the attached first digital signature with the retrieved individual public key; and
verifying the decrypted first digital signature to confirm an individual with access to individual private key sent the print document; whereby, trust of the identity of the individual is not permitted when said verifying step does not confirm an individual with access to individual private key sent the print document.

37. The method of claim 36, wherein the certificate is generated by a certificate authority.

38. The method of claim 35, wherein said trust determining step comprises generating a boolean trust value based on the score indicating whether the identity of the individual is trusted or not trusted.

39. A system for establishing trust in an identity of an individual in a transaction with a transacting entity, comprising:
an identification device that generates a print document including sample data and reference data; and
a terminal, communicatively coupled to said an identification device, whereby, the terminal can facilitate or enable the transaction when trust has been established based on said sample data and said reference data.

40. The system of claim 39, further comprising:
an identity service provider coupled to said terminal.

41. The system of claim 40, wherein said identity service provider performs at least one of extracting and matching operations on said sample data and said reference data.

42. The system of claim 39, wherein said an identification device comprises a handheld, wireless personal identification device.

43. A system for establishing trust in an identity of an individual in a transaction with a transacting entity, comprising:
means for generating a print document including sample data and reference data; and
means for establishing trust in the identity based on the sample data and reference data.

44. A system for establishing trust in an identity of an individual in a transaction with a transacting entity, comprising:
means for detecting a sample print of the individual at an identification device;
means for generating a print document that includes: identity data associated with the individual, a reference print associated with the individual, and the detected sample print;
means for sending the generated print document to a terminal;
means for forwarding the print document to an identity service provider;
means for retrieving a database print associated with the individual from a database;
means for extracting minutia data from the reference print, sample print, and database print;
means for determining a score indicative of a match condition of the extracted minutia data; and
means for determining whether to trust the identity of the individual based on the score, whereby, the transaction between the individual and the transacting entity can proceed when the identity of the individual is trusted.
